(19) United States
(12) Patent Application Publication
(10) Pub. No.: US 2003/0014405 A1
(43) Pub. Date: Jan. 16, 2003

(54) Search engine designed for handling long queries

(76) Inventors: Jacob Shapiro, Teaneck, NJ (US); Efim Gendler, Austin, TX (US); Igal Lichtman, Livingston, NJ (US)

Correspondence Address: RONALD E. BROWN, Pitney, Hardin, Kipp & Szuch LLP, 20th Floor, 711 Third Avenue, New York, NY, 10017, US

(21) Appl. No.: 09/901,539

(22) Filed: Jul. 9, 2001

(51) Int. Cl. G06F 7/00; G06F 17/30

(52) U.S. Cl. 707/5

(57) ABSTRACT

The search engine provides a method and apparatus for receiving long queries, assigning a weight to each relevant word of the query, allowing a user to reformulate the query before and/or after search on the basis of the weight of each word computed by the algorithm. The search engine further provides methods for decomposing a long query into several short queries based on the importance of terms computed by the algorithm. These generated queries are submitted to existing search engine(s) producing several ranked outputs, and the obtained ranked outputs are merged into one final ranked output.

### FIELD OF THE INVENTION

This invention pertains to an internet-based search engine that can use long queries in order to obtain more satisfactory search results.

### BACKGROUND OF THE INVENTION

The last decade has seen an introduction of the world wide web and search engines to help users find pages on the web that are relevant to users' information needs. A prior art typical search engine presents a user with a small box into which the query is typed (or pasted) by the user and a search engine returns a ranked list of links to pages together with their titles and short summaries. Over the years the quality of the returned results was substantially improved in most engines. However, for many queries the results are still very poor. One of the reasons for this phenomenon is the quality of an input from the user. This input is a representation of user's information need and if the user's information need is not described properly it is very difficult (and often impossible) to provide good results. A search engine should be capable of: 1) accepting a representation of user's information need without limiting it (either explicitly or implicitly) to a small number of terms; and 2) providing good search results if a user specifies long coherent query. The prior art search engines do not deal with these problems adequately. For example, they do not allow to type or paste a query past certain number of characters and do not allow to paste a text after carriage return. In cases where an engine allows a longer query, the existing algorithms generate output results that are often less than satisfactory.

Another important consideration in improving the quality of search results is to incorporate user's feedback into a search process. Most prior art search engines do not provide capabilities to include user's feedback and in few cases where some form of feedback is used it is not designed for long queries.

### SUMMARY OF THE PRESENT INVENTION

It is therefore an object of the present invention to provide a search engine for long queries in a web environment.

It is therefore a further object of the present invention to provide a search engine that gives improved quality searches.

It is therefore a still further object of the present invention to provide a search engine which can be used in intranet and extranet environments.

It is therefore a still further object of the present invention to provide a search engine which has an intuitive, user-friendly interface.

It is therefore a still further object of the present invention to provide a search engine which includes user feedback processing especially designed for long queries.

These and other objects are attained by providing a search engine which initially presents the user with a large box to enter the user's query, which is typically a long query. The user is presented with an opportunity to reformulate the query before search on the basis of the weight of each word computed by the search engine.

The search algorithms include query parsing which removes common words from the query; computing the weights of terms in the parsed query; creating an ordered list of terms by sorting the terms of the parsed query in descending order of their computed weights; presenting the ordered list of terms to the user prior to the search; decomposing the long query into a set of short queries using algorithms described herein below, submitting each constructed short query to the chosen search engine, obtaining a predefined number of documents in each query's output, and merging all the outputs into one ranked output by applying a ranking algorithm described herein below.

Additionally, the user is given the option for feedback before and/or after the search. In this feedback, the user is presented with a list of words in descending order of their weights. This order tells the user which words are considered the most important in the search. The user is then given the option of changing the order of the words, removing words, adding words, and/or constructing phrases. The resulting ordered set of words is then used by the search algorithm to perform a new search.

### DESCRIPTION OF THE DRAWINGS

Further objects and advantages of the invention will become apparent from the following description and claims, and from the accompanying drawings, wherein:

FIG. 1 is a flowchart of the present invention.

FIG. 2 is a plan view of a typical initial screen of the present invention as presented to the user.

FIG. 3 is a flowchart of the user's query processing in present invention.

FIG. 4 is a flowchart of the query refinement process in present invention.

FIG. 5 is a flowchart of the search process in present invention

FIG. 6 is a plan view of a typical ordered list of search terms presented to the user by the present invention before and/or after a search is performed.

FIG. 7 is a flowchart of the process for constructing short queries in present invention

### DETAILED DESCRIPTION OF THE PREFERRED EMBODIMENT

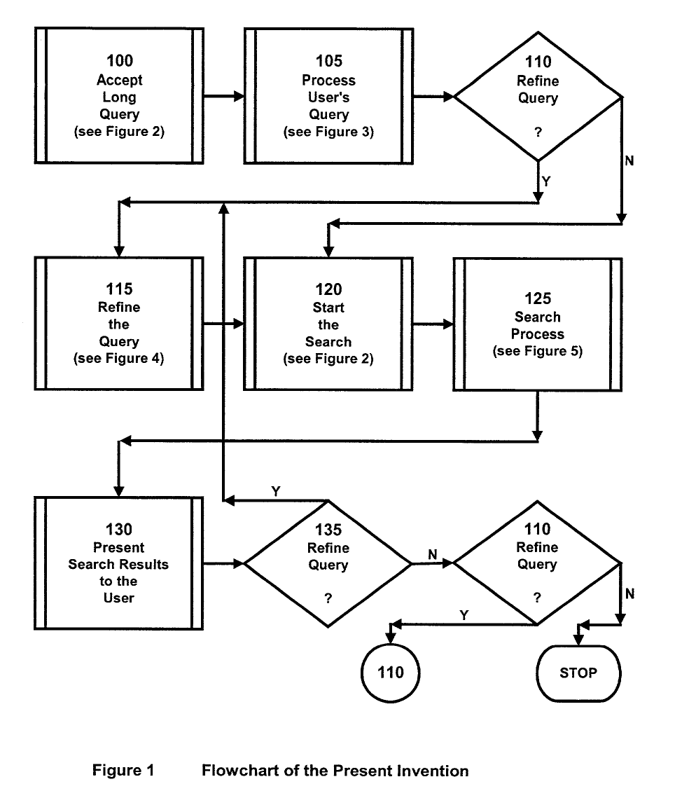

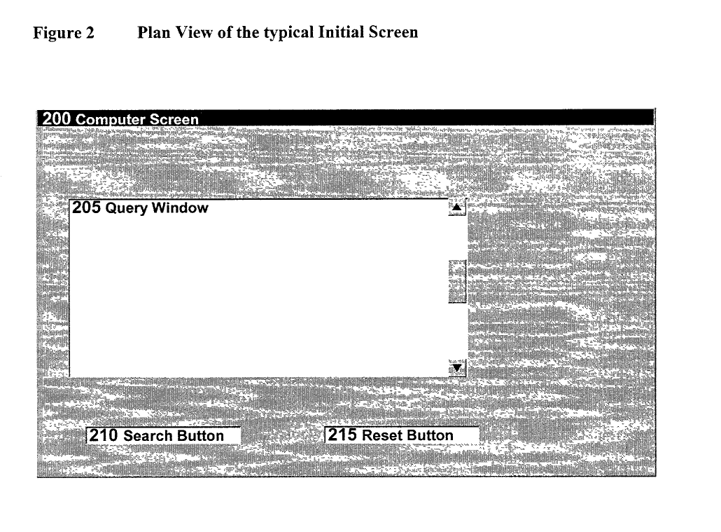

Referring now to the drawings in detail wherein like numerals refer to like elements throughout the several views, one sees a flowchart of the present invention in FIG. 1. Firstly, as shown in block 100, the user is presented with a relatively large Query Window 205 on computer screen 200 (see FIG. 2) into which the user enters a relatively long search query. Query Window 205 can accept pasted text from a document, Web page or e-mail. This provides the ability to find information based upon the example of an existing document. The size of Query window 205 allows the user to see the entire query, or at least a very large portion of the query.

Reset button 215 (which is actually a portion of the screen 200 which the user can “click” with a mouse or similar pointing instrument, as is known to those skilled in the art) allows a user to clear the prior query from Query Window 205.

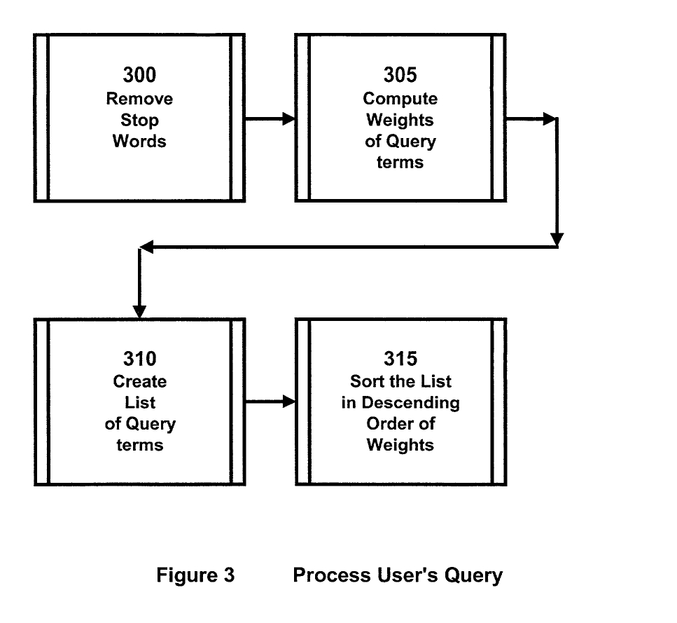

Once the user initiated the search process by clicking the Search Button 210 via mouse or similar pointing instrument the engine processes the user's query (see FIG. 3).

In block 300, common words (sometimes referred to as “stopwords”) are removed from the query. The user may maintain a special list of common words pertaining to a specific industry or application. In block 305, a computation of the word's weights in the parsed query is performed. The weight of the word represents the importance of the word in a search process and is typically computed as the product of TF (term frequency) and IDF (inverse document frequency). In Block 310 a list of all query terms with their computed weights is created and in Block 315 this list is ordered in descending order of computed weights.

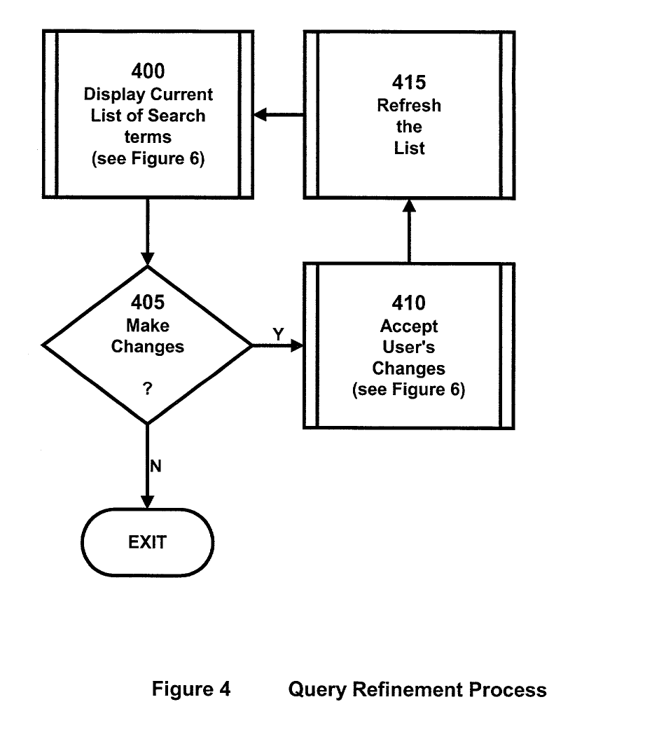

In Block 110 the user is given a choice whether to refine the query. Block 115 provides the user with the Refine Query process (see FIG. 4).

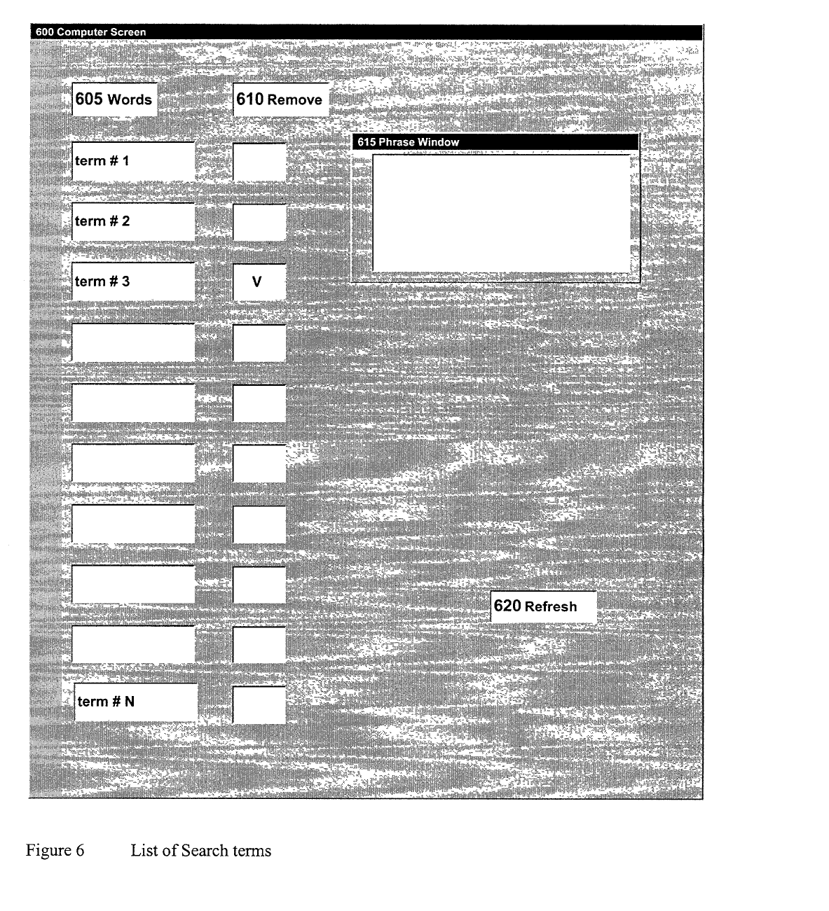

In block 400, the user is presented with the list of query words on computer screen 600 (see FIG. 6) in descending order of their weights (this order indicates which words are considered the most important in the search). At this point 405, the user is given an opportunity to refine the query 410. Refinement can be accomplished in one of several ways: change the order of the words (for example, by dragging the word 605 into a new position—higher or lower to make it more or less important), remove a word from the list by marking it (610), add a new word into the list with a position chosen by the user, and/or construct phrases in the Phrase Window (615) from the words on the list and choose the positions into which they are inserted. To review the changes again, the user may click the Refresh Button (620) and return to Block 415 which updates the word order (internally) and display the updated list again 400. At this point the user may continue with query refinements or proceed to the search process.

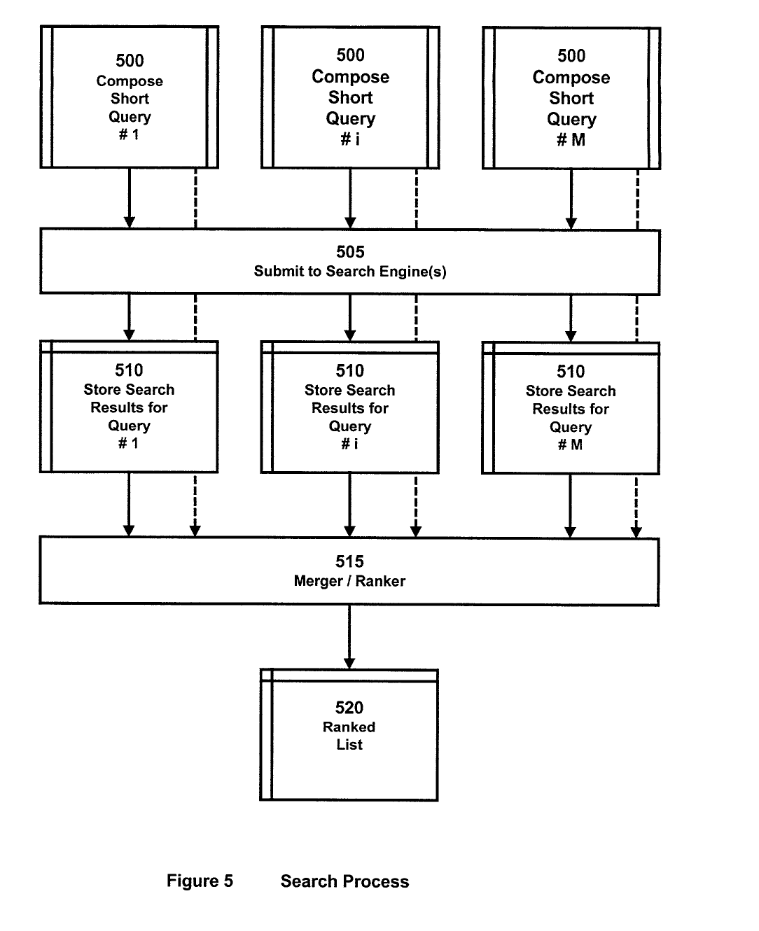

In Block 120 the user can start the search process by clicking Search Button 210 (which is actually a portion of the screen 200) with a mouse or similar pointing instrument. In Block 125 the actual search process takes place (see FIG. 5).

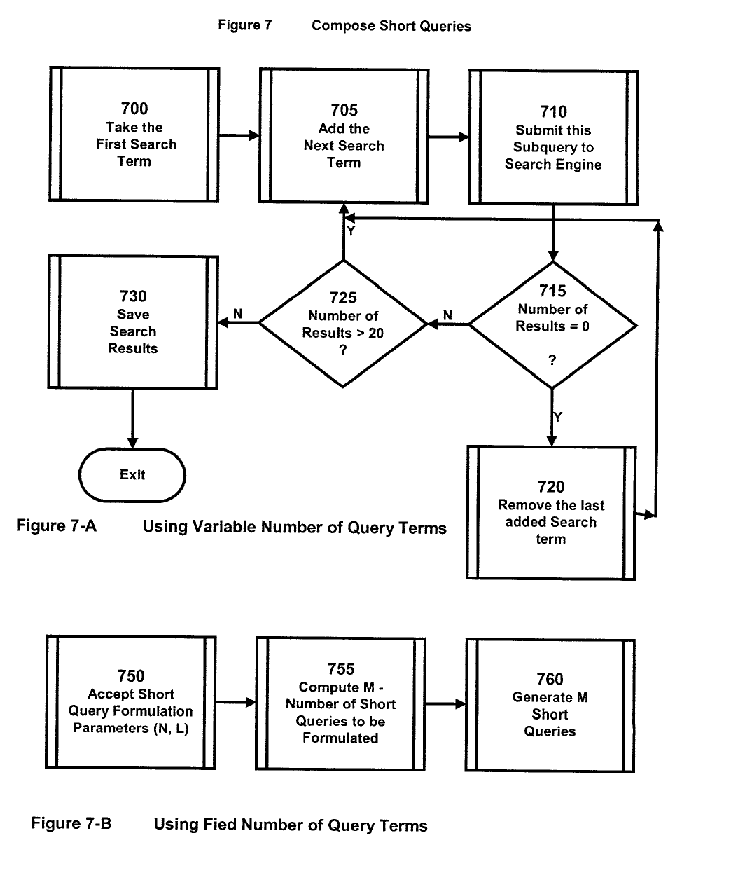

In block 500 a set of short queries is composed. This can be implemented in at least two different ways by choosing a variable subset of search terms (see FIG. 7-A) or fixed subset of search terms (see FIG. 7-B). Specific approach could vary depending upon computational resources and some additional information about the user's preferences.

The first approach is to use a variable number of terms from the original query but fix the number of queries to be constructed. A typical algorithm for such variable term decomposition of a long query sets M as the number of queries to be constructed. A typical value of M is four, but other values can be used depending upon the application, hardware capabilities and other circumstances. The construction of the first query starts with the first term (Block 700) in the ordered list of terms and iteratively adds more terms (Block 705) from the ordered list to construct a conjunctive query of the chosen terms. At each step of the iteration, the resulting query is submitted to an existing search engine (Block 710) which is typically internet or extranet-based. The choice of a search engine could be automatic by defaulting it to predefined search engine or the user may be given a choice to select an engine from a predefined list of search engines. The algorithms described in the present invention could be applied to any of the existing search engines. The iteration stops (Block 725) when the number of returned documents is less than some predefined number (such as, for instance, twenty), and the output results are stored for future use (Block 730). If a newly added term causes no results to be returned (Block 715), the newly added term is discarded (Block 720) and the next term on the list is used (Block 705). Construction of Queries 2 through M is similar to the construction of the Query₁ (i.e., the first query). That is, the i^{th} query starts with the i^{th} term from the ordered list of terms.

The second approach is to use a fixed number of consecutive search terms from the ordered list of query terms and a variable number of queries to be constructed. A typical algorithm for such approach accepts from the user query formulation parameters (Block 750). The first parameter N is the maximum number of terms from the ordered list to be used in short query construction and the second parameter L is the minimum number of terms in query. A typical value for N is 7 and L is 3, but other values can be used depending upon the application, hardware capabilities and other circumstances. The maximum number of documents to be used from the ranked outputs obtained from the constructed queries is represented by K. Block 755 computes the number of all possible subsets of terms from the list of N terms, where each subset has E elements (where L−1<E <M+1). The number of L-element subsets of a set with N elements, denoted by C(N, E), is equal to N!/(E! * (N-E)!). For instance, with an implementation of N=7 and L=3, then the total number of subsets is equal to C(7, 3)+C(7, 4)+C(7, 5)+C(7, 6)+C(7, 7)=99. This number of subsets can be indicated as M. Block 760 generates all possible such subsets. For each subset i (wherein 0<i<M+1), a conjunctive query (that is Queryᵢ) of all the terms in the subset is constructed. Regardless of the approach used to generate short queries the resulting queries are submitted to a search engine (Block 505). Typically this is going to be the same search engine as the one in block 710. After the search results are obtained (block 510), the top K documents are used to form a ranked output RLDᵢ (0<i<M+1).

The outputs or search results obtained in block 510 are merged into one ranked output by applying a ranking algorithm (block 515). The inputs to the ranking algorithm are the M queries (Query₁, . . . , Query_{M}) and corresponding ranked search results (RLD₁, . . . RLD_{M}) obtained in block 510. Each of the ranked output RLDᵢ contains, at most, K URL addresses ranked by the search engine. Firstly, the weight of each URL is calculated (within the output RLDᵢ) using its relative position from the top of the output RLDᵢ and the weight of Queryᵢ that produced this output. The weight of Queryᵢ, denoted by W_{Qi}, is the arithmetic average of the weights of its component terms and is calculated as follows:

$${W}_{{Q}_{i}} = \frac{{\sum }_{j = 1}^{m} {W}_{{t}_{j}}}{m}$$

where Wₜⱼ is the weight of search term tⱼ as calculated in Block 305 using typical TFxIDF measure and m is the number of search terms in Queryᵢ. All duplicate URLs are eliminated. However, the sum of the weights of the duplicate URLs is used as a new weight for the one remaining copy of the URL. The URLs are then arranged in descending order according to the respective weights. These search results are then presented to the user in block 130.

The user is then given a choice at decision block 130 to go to block 115 to refine the query and reformulate the search or at decision block 135 to clear the query window and return to block 100 to perform a new search. Thus the several aforementioned objects and advantages are most effectively attained.

Although preferred embodiments of the invention have been disclosed and described in detail herein, it should be understood that this invention is in no sense limited thereby.

What is claimed is:

1. A search engine including:
means for receiving an input query;
means for generating a list of words chosen from the input query and assigning a corresponding weight to each word from said list;
means for generating a set of queries based on a said list of words;
means for performing a series of searches based on said set of queries;
means for merging ranked results of said series of searches into a merged ranked search result; and
means for displaying said merged search result to a user.

2. The search engine of claim 1 further including means for displaying said list of words to a user and allowing the user to alter said list prior to performing said series of searches.

3. The search engine of claim 1 further including, subsequent to said means for displaying said merged search result, means for re-displaying said list of words to a user and allowing the user to alter said list.

4. The search engine of claim 1 wherein said means for performing a series of searches receives input from a means for decomposing said list of words into a variable number of terms and a fixed number of queries in said set of queries.

5. The search engine of claim 4 wherein said means for decomposing takes the first term in said list of words and iteratively adds successive terms from said list of words thereby constructing said set of queries as conjunctive queries.

6. The search engine of claim 5 wherein said means for decomposing stops iteratively adding successive terms when results from said series of searches in response to said set of queries exceeds a predetermined number of documents.

7. The search engine of claim 5 wherein said means for decomposing discards a given successive term when no results are returned in by one of said series of searches in response to a query from said set of queries including said given successive term.

8. The search engine of claim 7 wherein a next successive term is used to generate a query in said set of queries after said given successive term is discarded.

9. The search engine of claim 1 wherein said means for performing a series of searches receives input from a means for decomposing said list of words into a fixed number of terms and a variable number of queries in said set of queries.

10. The search engine of claim 9 wherein said fixed number of terms is calculated as all possible subsets based on a number of terms from said list of words and a minimum number of terms in a query in said set of queries.

11. The search engine of claim 1 wherein said means for generating a list of words from the input query and assigning a corresponding weight to each word from the list includes means for removing less relevant words from said input query, means for calculating said corresponding weight by calculating a product of term frequency and inverse document frequency; and means for ordering said list of words in accordance with said corresponding weight.

12. The search engine of claim 11 wherein said means for displaying said list of words displays said list of words in descending order of corresponding weight in accordance with said means for ordering said list of words.
